(19) United States
(12) Patent Application Publication
(10) Pub. No.: US 2004/0230965 A1
(43) Pub. Date: Nov. 18, 2004

(54) Mobile handset network that facilitates interaction between a generic intelligent responsive agent and a service broker server

(76) Inventor: Harri Okkonen, Laguna Niguel, CA (US)

Correspondence Address: Christopher C. Winslade, McAndrews, Held & Malloy, Ltd., 34th Floor, 500 West Madison Street, Chicago, IL, 60661, US

(21) Appl. No.: 10/788,768

(22) Filed: Feb. 27, 2004

Related U.S. Application Data
(60) Provisional application No. 60/450,977, filed on Feb. 28, 2003.

(51) Int. Cl. G06F 9/44

(52) U.S. Cl. 717/168; 717/171

(57) ABSTRACT

Disclosed herein is a method of managing services in electronic devices such as, for example, mobile handsets and their access to service providers via a service broker that is located on a server-side or in the device itself. An electronic device employing the service broker can manage the update of firmware/software, configuration, parameters etc. when a service needs to be provisioned, updated or changed. In general, various components in the electronic device, such as the firmware, operating system, applications or other components, access services provided by an associated one of a plurality of service providers, by employing the services of a generic intelligent responsive agent located in the electronic device. The generic intelligent responsive agent acts as a proxy in one embodiment or as a surrogate in another embodiment. It is capable of interacting with a service broker server that facilitates communication and interactions with one or more service providers.

### CROSS-REFERENCE TO OTHER APPLICATIONS

The present application claims the benefit of U.S. Provisional patent application having serial No. 60/450,977, filed on Feb. 28, 2003, and hereby incorporates herein by reference the complete subject matter thereof, in its entirety.

The present application also hereby incorporates herein by reference the complete subject matter of PCT application having publication number WO/02/41147 A1, and having application number PCT/US01/44034, filed on Nov. 19, 2001, in its entirety.

The present application also hereby incorporates herein by reference the complete subject matter of the following U.S. Provisional patent applications: serial number Serial No. 60/373,422, filed Apr. 12, 2002, which is also incorporated by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both.

Electronic devices, such as mobile handsets, comprise a plurality of firmware and/or software components. These components need to access individual service providers in an operator's network or outside the operator's network. These components need visibility to their corresponding service providers. Often, these components have trouble discovering details about their associated service providers or in gaining access to them.

Further limitations and disadvantages of conventional and traditional approaches will become apparent to one of skill in the art, through comparison of such systems with some aspects of the present invention as set forth in the remainder of the present application with reference to the drawings appended hereto.

### SUMMARY OF THE INVENTION

Aspects of the present invention may be found in a network that facilitates interactions between one of a plurality of software components in a electronic device and an associated one of a plurality of servers in the network. The network comprises a service broker capable of receiving at least one request for service associated with one of the plurality of software components. The service broker is capable of determining the one of the plurality of servers associated with the one of the plurality of software components, based upon the at least one request for service. The service broker is also capable of forwarding the at least one request for service to the determined one of the plurality servers.

In one embodiment, the network further comprises the service broker capable of selectively communicating a response from the determined one of the plurality of servers to one of the plurality of software components in the electronic device.

In another embodiment, the service broker is a software component in the electronic device.

In a related embodiment, one of the plurality of servers comprises a download server capable of receiving a request for an update package, the download server capable of sending the requested update package to one of the plurality of software components in the electronic device.

In another related embodiment, the update package comprises a set of executable instructions for converting a first version of a software component to a second version of the software component.

In one embodiment, the service broker forwards the update package to at least one of the plurality of software components in the electronic device.

In another embodiment, one of the plurality of software applications in the electronic device comprises an update agent capable of processing an update package, the update agent capable of being invoked by the service broker when an update package is communicated to the electronic device.

In a related embodiment, the update package comprises a set of executable instructions for converting a first version of a software component to a second version of the software component.

In another embodiment of the network, the at least one request for service comprises an asynchronous request and the service broker is capable of communicating a response received from one of the plurality of servers back to the one of the plurality of software components.

In a different embodiment, the at least one request for service comprises an asynchronous request. The one of the plurality of software components registers callback information with the service broker. The service broker communicates a response received from one of the plurality of servers back to the one of the plurality of software applications based upon the registered callback information.

In a different embodiment of the network, the service broker is a server communicatively coupled to the electronic device.

In another embodiment, the service broker server determines which one of the plurality of servers is available and capable of processing the at least one service request, and subsequently forwards the request to the determined one of the plurality of servers.

In another embodiment, the determined one of the plurality of servers is forwarded the at least one request for processing, and a response from the determined one of the plurality of servers is forwarded to the one of the plurality of software components.

Again, in another embodiment, the determined one of the plurality of servers processes the at least one service request, the at least one service request comprising a request for a software update from the one of the plurality of software components. It then retrieves an update package and associated information and communicates the update package and associated information to the electronic device.

In a different embodiment, the plurality of software components comprises a download agent and an update agent. The download agent is capable of requesting a software update from the service broker server, and receiving in response an update package from the service broker server. The update agent is capable of processing the received update package for updating at least one of firmware and software in the electronic device.

In a different embodiment, a wireless network supports at least one electronic device. The network comprises a service broker, a plurality of service providers, each of the plurality of service providers communicatively coupled to the service broker and a client-side component in the electronic device that requests a software update from one of the plurality of service providers. The service broker determines the appropriate one of the plurality of service providers that is capable of responding to the software update request.

In a related embodiment, the wireless network further comprises a generic intelligent responsive agent in the electronic device, the generic intelligent responsive agent communicatively coupled to the service broker. The generic intelligent responsive agent is capable of establishing a communication link with the service broker server. It is also capable of forwarding the software update request and associated information from the client-side component to the service broker. The service broker server determines one of the plurality of service providers as a target server capable of processing the software update request and forwarding the software update request to the target server.

In another related embodiment of the wireless network of claim, the target server processes the received software update request, retrieves an appropriate update package and associated information, and communicates the appropriate update package and associated information back to the generic intelligent responsive agent for subsequent communication to an associated client-side component.

In another related embodiment, the generic intelligent responsive agent acts as a proxy for the client-side component and provides one of asynchronous communication and synchronous communication facilities for interactions with the target server.

In another embodiment, the electronic device further comprises a registration client capable of maintaining a plurality of registration entries, each registration entry associated with a client-side software component, each entry comprising at least one of a name, a version, a plurality of dependencies, a status that specifies current operational status, a plurality of callback functions, an associated parameter, an event, and a return type. It also comprises a set of configuration parameters and a client-side software component specific update agent capable of updating at least one of the set of configuration parameters and the client-side software component. In addition, it also comprises a server URL that specifies a service provider and associated relevant information.

In a related embodiment of the wireless network, the electronic device further comprises security information.

Aspects of the invention may also be found in a method for updating at least one of a software component and software component configuration information in a electronic device communicatively coupled to a service broker. The method comprises, under the control of the electronic device, registering at least one call-back function available in the software component, communicating, to the service broker, a request for updating of at least one of the software component and software component configuration, receiving results from a remote service provider and invoking the at least one call-back function using the received results. It also comprises, under the control of the service broker, receiving an update request, determining a service provider based upon the update request, invoking update functionality on the determined service provider and transmitting results of the invoked update functionality to the mobile device.

In a related method, under the control of the electronic device, the received results are communicated to an update agent capable of updating the at least one of the software component and software component configuration.

In an embodiment of the method, under the control of the electronic device, a request is communicated by the software component to a generic intelligent responsive agent, the request comprising a command to be invoked on a remote service provider and parameters to be passed to it. The request is communicated to the service broker and the received results are communicated to the software component. In addition, under the control of the service broker, an update request is received, based upon the update request a service provider is determined, the update functionality is invoked on the determined service provider and results of the invoked update functionality is transmitted to the generic intelligent responsive agent.

These and various other advantages and features of novelty which may characterize the invention are pointed out with particularity in the claims annexed hereto and that form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DIAGRAMS

The numerous objects and advantages of the present invention may be better understood by those skilled in the art by reference to the accompanying figures in which:

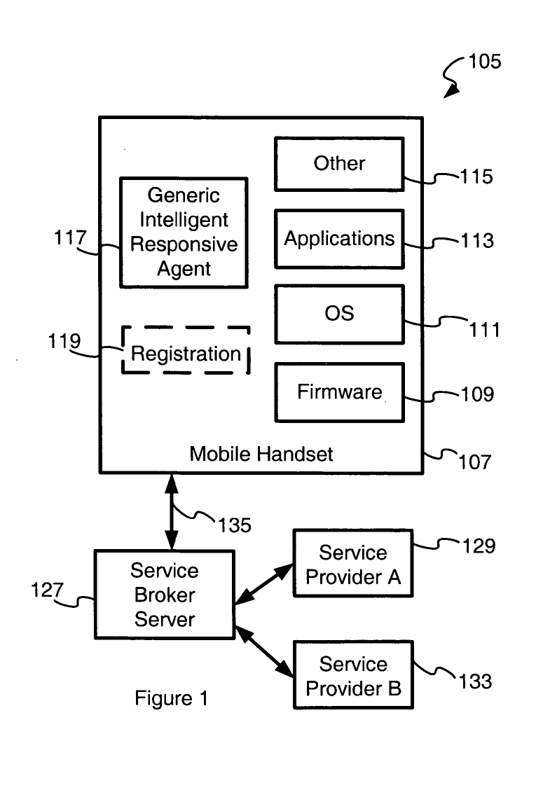

FIG. 1 is a perspective diagram of a mobile handset network that facilitates interaction between various software components in a mobile handset, such as a firmware, an operating system (OS), applications, other components, etc., with corresponding service providers in the network, such as a service provider A, a service provider B, etc., via a generic intelligent responsive agent in the mobile handset and a service broker server to which the mobile handset is communicatively coupled, in accordance with an embodiment of the present invention; and

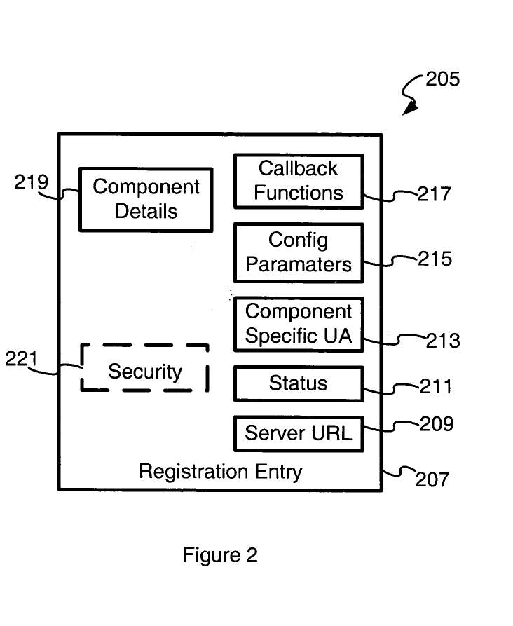

FIG. 2 is a perspective block diagram of an exemplary registration entry that is used to save registration information in the registration for all the components currently available in the mobile handset, such as the firmware, OS, applications or other components, in accordance with an embodiment of the present invention.

### DETAILED DESCRIPTION OF THE DIAGRAMS

FIG. 1 is a perspective diagram of a mobile handset network 105 that facilitates interaction between various software components in a mobile handset 107, such as a firmware 109, an operating system (OS) 111, applications component 113, other components 115, etc., with corresponding service providers in the network, such as a service provider A 129, a service provider B 133, etc., via a generic intelligent responsive agent 117 in the mobile handset 107 and a service broker server 127 to which the mobile handset 107 is communicatively coupled, in accordance with an embodiment of the present invention. In the following discussion, the term “software components” is used to refer to both software and firmware components. In addition, although the following text refers to a “mobile handset”, an embodiment of the present invention may be employed with respect to other electronic devices such as, for example, a personal digital assistant (PDA), a personal computer (PC), a pager, etc.

In an embodiment of the present invention, various software components in the mobile handset 107, such as the firmware 109, OS 111, applications component 113 or other components 115, may access services provided by an associated service provider, such as the service provider A 129 or the service provider B 133, by employing the services of the generic intelligent responsive agent 117 located in the mobile handset 107. The generic intelligent responsive agent 117 may act as a proxy in one embodiment or as a surrogate in another embodiment.

The generic intelligent responsive agent 117 may interact with the service broker server 127 on behalf of the firmware 109, OS 111, applications component 113 or other components 115. The generic intelligent responsive agent 117 may forward requests for information, requests for configuration parameters, requests for service, requests for updates, etc. initiated by the software components 109, 111, 113, 115 to the service broker server 127, which in turn may determine the final destination of such requests and forward the requests. Any results or responses from such requests may be returned to an initiating software component 109, 111, 113, 115.

In one embodiment of the present invention, a client-side software component, such as the applications component 113, may desire an update to its software from a service provider, although it may not know to which service provider to communicate a request. Instead, the client-side software component may forward the request for the software update to the generic intelligent responsive agent 117, which, in turn, may establish a communication link 135 with the service broker server 127 and forward the software update request along with associated information about the mobile handset 107, the applications component 113, optionally the end-user, etc. The communication link 135 may comprise a wireless communication link such as, for example, a cellular, personal communication services (PCS), or paging service, or a wired communication link such as, for example, a local area network (LAN) or conventional switched telephone network. The service broker server 127 may determine which of the available service providers 129, 133 is capable of processing the request and providing the associated service. The service broker server 127 may then forward the received software update request to one of the appropriate service providers, such as the service provider A 129, which, in turn, may process the received request for a software update, retrieve an update package and associated information, and communicate the update package and associated information back to the mobile handset 107. In an embodiment of the present invention, an update package may comprise a set of executable instructions for converting a first version of software/firmware into a second version of software/firmware. Such communication of the response, such as the update package and associated information, back to the mobile handset 107 may be executed in a “synchronous” mode in one related embodiment, and in an “asynchronous” mode in another related embodiment.

In one embodiment of the present invention, the client-side components, such as firmware 109, OS 111, applications component 113 or other components 115, may each register themselves (such as during their installation, or at manufacturing time at the factory) with a registration client 119 that keeps track of all registered components and provides facilities to access and communicate with the components (based on security and capabilities of the components). For example, the applications component 113 may register itself, during installation, with the registration client 119 and may also provide information of callback functions and associated events or response types that will handle incoming events or responses. Specifically, each callback function may provide a handle by which the generic intelligent responsive agent 117 can communicate with the applications component 113, as required, such as when a response is received from a service provider to which a request for information had been sent previously. Such behavior may be described as operating in an “asynchronous mode”. In contrast, another embodiment of the present invention operating such that the applications remain active to receive incoming events or responses without the use of callback functions may be described as operation in a “synchronous mode”. In one related embodiment of the present invention, the optional registration client 119 may also keep track of configuration parameters for the applications component 113 (and for other components 109, 111, 115, etc.), including information concerning where update packages received from external systems should be saved, locations and types of status flags that need to be set based on received responses, events, etc., and other component specific information.

In one embodiment of the present invention, the registration client 119 may interact with a remote registration service accessible via the service broker server 127 whenever a new application or software component registers itself with the registration client 119. In addition, the service broker server 127 may interact with the remote registration service to retrieve configuration information and other relevant information associated with the software components currently available in the mobile handset 107.

In an embodiment of the present invention, the service broker server 127 may be employed by each software component or each software object currently available in the mobile handset 107, via the generic intelligent responsive agent 117, so as to be able to manage/update themselves by retrieving configuration parameters or software updates from appropriate service providers that are known to, discovered by, or accessible from, the service broker server 127.

In one embodiment of the present invention, the service provider A 129 may be capable of communicating with a specific software component in the mobile handset 107, such as the applications component 113, by requesting the service broker server 127 to seek the services of the generic intelligent responsive agent 117 in establishing a communication link with the software component (such as the applications component 113) and in facilitating interactions with the software component. In a related embodiment of the present invention, the generic intelligent responsive agent 117 may employ the information provided by the registration client 119 to access the associated component, such as the applications component 113, being remotely invoked or remotely communicated with.

In one embodiment of the present invention, when one of the applications component 113 (an originating application) is invoked, a remote service provided by the service provider A 129 may be invoked. Specifically, the application being invoked may interact with the generic intelligent responsive agent 117 and communicate necessary information, such as the command to be invoked on a remote service and parameters to be passed to it. In response, the generic intelligent responsive agent 117 may interact with the service broker server 127 in order to locate and forward a command and associated parameters to the service provider A 129. The service broker server 127 may invoke the requested command on the service provider A 129, retrieve results, if any, from it, and send the results back to the generic intelligent responsive agent 117 for their eventual return to the originating application. The generic intelligent responsive agent 117 may employ an appropriate call back function previously registered by the originating application (in the registration client 119) to return the results to the originating application (say, one of the applications component 113).

In one embodiment of the present invention, the software components in the mobile handset 107, such as the firmware 109, OS 111, applications component 113 or other components 115, may all be selectively addressable and capable of being remotely invoked by the service providers, such as the service provider A 129 and the service provider B 133, via the service broker server 127. In a related embodiment of the present invention, the software components in the mobile handset 107 may be provisioned by remote service providers, employing the combination of the service broker server 127 and the generic intelligent responsive agent 117 as a common gateway for provisioning or as a generic mechanism employed to provision each software component.

FIG. 2 is a perspective block diagram of an exemplary registration entry that may be used to save registration information in the registration client 119 for all the software components currently available in the mobile handset, such as the firmware 109, OS 111, applications component 113, or other components 115, in accordance with an embodiment of the present invention. The registration entry 207 of FIG. 2 may, for example, comprise component details 219 such as, for example, the software component name, version(s), dependencies, etc.; callback functions 217 that may present a list of callback functions in the software component, the associated parameters of the callback functions, associated events or callback function return types, etc.; configuration parameters 215 that contains various configuration parameters; a software component specific update agent 213 that is capable of updating the configuration parameters and/or the associate software; status information 211 that specifies current operational status; a server URL 209 that specifies service provider related URL information and associated relevant information; and optional security information 221.

In an embodiment of the present invention, various software components in the mobile handset, such as the firmware 109, OS 111, applications component 113, or other components 115 shown in FIG. 1, may access services provided by an associated one of a plurality of service providers, by employing the services of a generic intelligent responsive agent located in the mobile handset, such as the generic intelligent responsive agent 117 of FIG. 1. The generic intelligent responsive agent 117 may act as a proxy in one embodiment or as a surrogate in another embodiment. The generic intelligent responsive agent 117 may be capable of interacting with a service broker server such as, for example, the service broker server 127 of FIG. 1, that facilitates communication and interactions with one or more service providers.

Although a system and method according to the present invention has been described in connection with a preferred embodiment, the invention is not intended to be limited to the specific form set forth herein, but on the contrary, is intended to cover such alternative modifications and equivalents, as can be reasonably included within the spirit and scope of the invention, as defined by this disclosure and the appended diagrams. It is intended that the scope of the invention be limited not with this detailed description, but rather by the claims appended hereto.

What is claimed is:

1. A network that facilitates interactions between one of a plurality of software components in a electronic device and an associated one of a plurality of servers in the network, the network comprising:
a service broker capable of receiving at least one request for service associated with one of the plurality of software components;
the service broker capable of determining the one of the plurality of servers associated with the one of the plurality of software components, based upon the at least one request for service; and
the service broker capable of forwarding the at least one request for service to the determined one of the plurality servers.

2. The network of claim 1 further comprising:
the service broker capable of selectively communicating a response from the determined one of the plurality of servers to one of the plurality of software components in the electronic device.

3. The network of claim 1 wherein the service broker is a software component in the electronic device.

4. The network of claim 1 wherein one of the plurality of servers comprises a download server capable of receiving a request for an update package, the download server capable of sending the requested update package to one of the plurality of software components in the electronic device.

5. The network of claim 4 wherein the update package comprises a set of executable instructions for converting a first version of a software component to a second version of the software component.

6. The network of claim 4 wherein the service broker forwards the update package to at least one of the plurality of software components in the electronic device.

7. The network of claim 1 wherein one of the plurality of software applications in the electronic device comprises an update agent capable of processing an update package, the update agent capable of being invoked by the service broker when an update package is communicated to the electronic device.

8. The network of claim 7 wherein the update package comprises a set of executable instructions for converting a first version of a software component to a second version of the software component.

9. The network of claim 1 wherein:
the at least one request for service comprises an asynchronous request; and
the service broker capable of communicating a response received from one of the plurality of servers back to the one of the plurality of software components.

10. The network of claim 1 wherein:
the at least one request for service comprises an asynchronous request;
the one of the plurality of software components registers callback information with the service broker; and
the service broker communicates a response received from one of the plurality of servers back to the one of the plurality of software applications based upon the registered callback information.

11. The network of claim 1 wherein the service broker is a server communicatively coupled to the electronic device.

12. The network of claim 11 wherein the service broker server determines which one of the plurality of servers is available and capable of processing the at least one service request, and subsequently forwards the request to the determined one of the plurality of servers.

13. The network of claim 12 wherein the determined one of the plurality of servers is forwarded the at least one request for processing, and a response from the determined one of the plurality of servers is forwarded to the one of the plurality of software components.

14. The network of claim 12 wherein the determined one of the plurality of servers:
processes the at least one service request, the at least one service request comprising a request for a software update from the one of the plurality of software components;
retrieves an update package and associated information; and
communicates the update package and associated information to the electronic device.

15. The network of claim 14 wherein:
the plurality of software components comprises a download agent and an update agent;
the download agent is capable of requesting a software update from the service broker server, and receiving in response an update package from the service broker server; and
the update agent is capable of processing the received update package for updating at least one of firmware and software in the electronic device.

16. A wireless network supporting at least one electronic device, the network comprising:
a service broker;
a plurality of service providers, each of the plurality of service providers communicatively coupled to the service broker;
a client-side component in the electronic device that requests a software update from one of the plurality of service providers; and
the service broker determining the appropriate one of the plurality of service providers capable of responding to the software update request.

17. The wireless network of claim 16 further comprising:
a generic intelligent responsive agent in the electronic device, the generic intelligent responsive agent communicatively coupled to the service broker;
the generic intelligent responsive agent capable of establishing a communication link with the service broker server;
the generic intelligent responsive agent capable of forwarding the software update request and associated information from the client-side component to the service broker; and
the service broker server determining one of the plurality of service providers as a target server capable of processing the software update request and forwarding the software update request to the target server.

18. The wireless network of claim 17 wherein the target server:
processes the received software update request;
retrieves an appropriate update package and associated information; and
communicates the appropriate update package and associated information back to the generic intelligent responsive agent for subsequent communication to an associated client-side component.

19. The wireless network of claim 18 wherein the generic intelligent responsive agent:
acts as a proxy for the client-side component; and
provides one of asynchronous communication and synchronous communication facilities for interactions with the target server.

20. The wireless network of claim 19 wherein the electronic device further comprises:
a registration client capable of-maintaining a plurality of registration entries, each registration entry associated with a client-side software component, each entry comprising at least one of a name, a version, a plurality of dependencies, a status that specifies current operational status, a plurality of callback functions, an associated parameter, an event, and a return type;
a set of configuration parameters;
a client-side software component specific update agent capable of updating at least one of the set of configuration parameters and the client-side software component; and
a server URL that specifies a service provider and associated relevant information.

21. The wireless network of claim 20 wherein the electronic device further comprises security information.

22. A method for updating at least one of a software component and software component configuration information in a electronic device communicatively coupled to a service broker, the method comprising:
under the control of the electronic device,
registering at least one call-back function available in the software component;
communicating, to the service broker, a request for updating of at least one of the software component and software component configuration;
receiving results from a remote service provider; and
invoking the at least one call-back function using the received results, under the control of the service broker,
receiving an update request;
determining a service provider based upon the update request;
invoking update functionality on the determined service provider; and
transmitting results of the invoked update functionality to the mobile device.

23. The method according to claim 22 further comprising:
under the control of the electronic device,
communicating the received results to an update agent capable of updating the at least one of the software component and software component configuration.

24. The method according to claim 22 further comprising:
under the control of the electronic device,
communicating a request by the software component to a generic intelligent responsive agent, the request comprising a command to be invoked on a remote service provider and parameters to be passed to it;
communicating the request to the service broker; and
communicating the received results to the software component, under the control of the service broker,
receiving an update request;
determining a service provider based upon the update request;
invoking update functionality on the determined service provider; and
transmitting results of the invoked update functionality to the generic intelligent responsive agent.
